(19) United States
(12) Patent Application Publication
(10) Pub. No.: US 2014/0249689 A1
(43) Pub. Date: Sep. 4, 2014

(54) SYSTEM AND METHOD FOR CONTROLLING THERMOGRAPHIC MEASURING PROCESS

(71) Applicant: SIEMENS AKTIENGESELLSCHAFT, München (DE)

(72) Inventors: Lukasz Adam Bienkowski, Munchen (DE); Christian Homma, Vaterstetten (DE)

(73) Assignee: SIEMENS AKTIENGESELLSCHAFT, Munchen (DE)

(21) Appl. No.: 13/261,866

(22) PCT Filed: Oct. 31, 2012
(86) PCT No.: PCT/EP2012/071563

§ 371 Date: May 14, 2014

(30) Foreign Application Priority Data
Nov. 14, 2011 (DE) 10 2011 086 267.6

(51) Int. Cl. G05B 15/02

(52) U.S. Cl. CPC G05B 15/02
USPC 700/299

(57) ABSTRACT

A test specimen, on which control functions and/or thermographic measuring results are projected, undergoes a thermographic measuring process using at least one depth sensor. Actuation of the thermographic measuring procedure takes place subject to the sensor-captured body gestures. Specifically, body gestures of a user select the control functions and/or recording of the thermographic measuring results.

### CROSS REFERENCE TO RELATED APPLICATIONS

This application is the U.S. national stage of International Application No. PCT/EP2012/071563, filed Oct. 31, 2012 and claims the benefit thereof. The International Application claims the benefit of German Application No. 102011086267.6 filed on Nov. 14, 2011, both applications are incorporated by reference herein in their entirety.

### BACKGROUND

Described below are a system and a method for controlling a thermographic measuring process on an inspection article.

In known applications, it is necessary to inspect an inspection article, for example an industrially manufactured item, nondestructively with respect to its functionality. Various nondestructive material inspection methods are known therefor, for example visual detection of faults on the surface of inspection objects or so-called dye penetrant inspection, in which a dye penetrates into cracks or other defects of inspection articles and can be optically recorded. In the case of visual inspection, the inspection object is inspected by eye or with the aid of suitable magnifying optics. In this way, irregularities, for example dirt, deposits, discolorations, detachment of layers, notches, dents, scratches or the like can be identified. With the dye penetrant method, for example, the evaluation may also be carried out in the dark with the aid of UV light. However, known inspection methods of this type have the substantial disadvantage that these methods are dependent on a subjective impression of the respective person carrying out the inspection, and are therefore relatively unreliable.

Methods which employ thermography are therefore increasingly being used as inspection methods. Distinction may be made between passive and active thermography. In active thermography, an object to be inspected, or an inspection article, is heated at least locally by external stimulation by an energy source.

Heat produced in the inspection object is then recorded with the aid of a thermal imaging camera. In contrast thereto, in passive thermography the inspection article to be inspected itself has an energy source.

So-called real-view thermography allows convenient observation of measurement results, in particular thermographic measurement results, directly on the inspection article to be inspected. In known systems for the thermographic measurement of inspection articles, however, an interaction takes place between the tester and the system by known input devices, for example a keyboard or a computer mouse. In many applications, this constitutes a significant restriction for the tester carrying out the inspection, particularly in robust climatic environments, or process environments and locations where the tester's freedom of movement is greatly restricted. Furthermore, it is often not possible for the tester carrying out the inspection to access known input devices of this type, such as a keyboard or mouse, at the locations to be inspected of the inspection article to be inspected. In known systems, furthermore, the tester carrying out the inspection is distracted from the actual inspection process, or the evaluation of the inspection article, by operating the known input devices, such as a keyboard and mouse. Another disadvantage of known thermographic inspection systems is that in many cases the input devices used are greatly contaminated because of the environmental conditions, and are therefore error-prone.

### SUMMARY

Described below are a system and a method for controlling a thermographic measuring process on an inspection article, in which a tester or user can control the measuring process in a straightforward way, without being restricted in his flexibility or distracted by interaction with input devices.

Accordingly, the system controls a thermographic measuring process on an inspection article, onto which control functions and/or thermographic measurement results are projected, wherein body gestures of a user for selecting the control functions and/or the thermographic measurement results are recorded by at least one depth sensor, and the thermographic measuring process is controlled as a function of the body gestures recorded by sensing.

The system offers the advantage that a thermographic measuring process can be controlled reliably by the controller in any environment, even when the user's freedom of movement is restricted.

Another advantage of the system is that the thermographic measuring process can be carried out substantially independently of environmental influences.

Another advantage of the system is that the user can carry out the evaluation of the inspection while concentrating when carrying out the control process for controlling a thermographic measuring process, without being distracted by operating known input devices.

Another advantage of the system for controlling a thermographic measuring process on an inspection article is that there is a unique correspondence for the tester between a fault found on the inspection article and the respective measurement result. In this way, the system and method work particularly reliably in respect of fault identification.

In one possible embodiment of the system, the depth sensor used is a 3D camera which records a body gesture, in particular a hand gesture or a facial expression, of the user and generates a corresponding three-dimensional image of the body gesture of the user.

In one possible embodiment of the system, the depth sensor is connected to a controller which evaluates the generated three-dimensional image of the body gesture in order to determine the control function selected by the user and/or the measurement results selected by the user.

In one possible embodiment of the system, the controller is connected to an image projector which projects the control functions and/or the thermographic measurement results onto the inspection article.

In one possible embodiment of the system, the thermographic measurement used is an active thermographic measuring process, in which energy is introduced into the inspection article by an external energy source and is radiated as heat by the inspection article.

In one alternative embodiment of the system, the thermographic measurement used is a passive thermographic measuring process, in which the inspection article itself has an internal energy source, the energy of which the inspection article radiates as heat.

In one possible embodiment of the system, the heat radiated by the inspection article is recorded by sensing using a thermal imaging camera, which generates a thermographic thermal image of the inspection article.

In another possible embodiment of the system, the generated thermographic thermal image of the inspection article is projected as a thermographic measurement result onto the inspection article itself.

In another possible embodiment of the system, a movement and an orientation of the depth sensor and/or of the thermal imaging camera are controlled by the controller as a function of a body gesture of the user recorded by sensing.

In another possible embodiment of the system, the control functions projected onto the inspection article include menu control functions.

In one possible embodiment of the system, the projected control functions include control functions for the selection of a thermographic measurement method.

In another possible embodiment of the system, the control functions are control functions for the selection of a spatial and/or temporal measurement range.

In another possible embodiment of the system, the control functions include control functions for the selection and/or setting of measurement parameters.

In another possible embodiment of the system, the control functions include control functions for the loading of existing measurement results and/or measurement data of the inspection article.

In another possible embodiment of the system, the control functions include control functions for the marking of at least one subregion of the inspection article.

In another possible embodiment of the system, the control functions include control functions for the erasing or deletion of projected measurement results and/or measurement data of the inspection article.

In another possible embodiment of the system, the control functions include control functions for showing and hiding of a virtual flashlight, with the aid of which the inspection result can be overlaid in a predefined region.

In another possible embodiment of the system, the control functions include control functions for the zooming of the thermal imaging camera onto a spatial measurement range of the inspection article.

In another possible embodiment of the system, the control functions include control functions for the evaluation of the inspection article.

In another possible embodiment of the system, the control functions include control functions for the generation of a measurement report for the respective inspection article.

In another possible embodiment of the system, the control functions include control functions for the evaluation of the thermographic measurement results of the respective inspection article.

In another possible embodiment of the system, the depth sensor is arranged at an adjustable angle relative to a connecting line extending between the user and the inspection article, in order to record the body gestures of the user and/or the control functions projected onto the inspection article and the projected measurement results in a spatial relation with respect to the user.

In one possible embodiment of the system, the depth sensor is carried by the user, in particular on a helmet of the user.

In another possible embodiment of the system, the thermal imaging camera is carried by the user, in particular on a helmet of the user.

In another possible embodiment of the system, the image projector is carried by the user, in particular on a helmet of the user.

In another possible embodiment of the system, a movement device for the movement of the user, in particular a lifting mechanism, is controlled as a function of the body gestures of the user recorded by sensing.

The method described below controls a thermographic measuring process on an inspection article.

Accordingly, the method controls a thermographic measuring process on an inspection article, onto which control functions and/or thermographic measurement results are projected, wherein body gestures of a user for selecting the control functions and/or the thermographic measurement results are recorded, and the thermographic measuring process is controlled as a function of the body gestures recorded by sensing.

### BRIEF DESCRIPTION OF THE DRAWINGS

These and other aspects and advantages will become more apparent and more readily appreciated from the following description of the exemplary embodiments of the system and method for controlling a thermographic measuring process on an inspection article with reference to the appended drawings, in which:

FIG. 1 is a block diagram of one exemplary embodiment of a system for controlling a thermographic measuring process on an inspection article;

FIG. 2 is a block diagram of another exemplary embodiment of a system for controlling a thermographic measuring process on an inspection article;

FIG. 3 is a block diagram of another exemplary embodiment of a system for controlling a thermographic measuring process on an inspection article.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

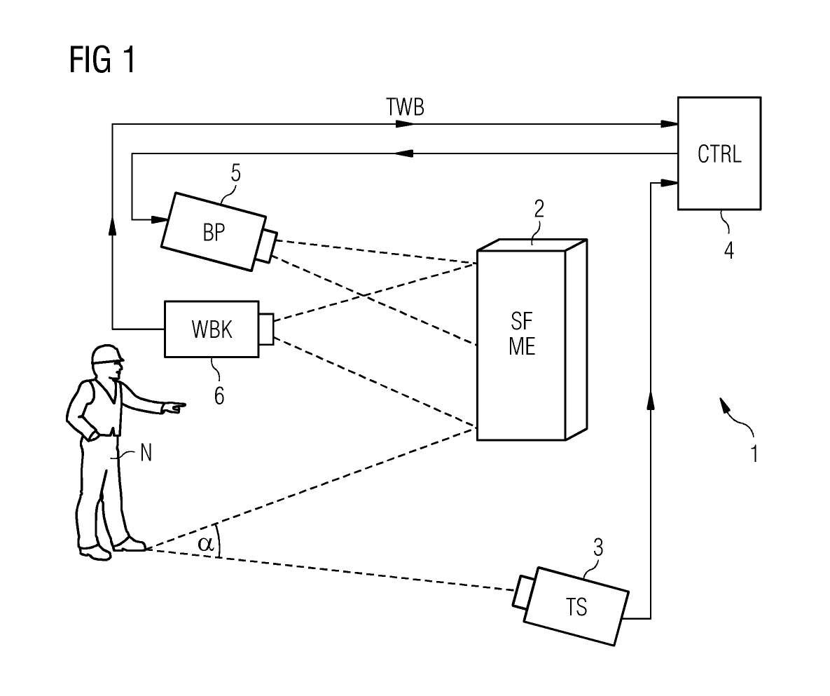

As can be seen from FIG. 1, a system 1 for controlling a thermographic measuring process on an inspection article 2 has at least one depth sensor 3, which is connected to a controller 4. In the exemplary embodiment represented in FIG. 1, the system 1 furthermore includes an image projector 5, which is controlled by the controller 4. The controller 4 furthermore receives thermal images of the inspection article 2 from a thermal imaging camera 6. The thermal imaging camera 6 records the heat radiated by the inspection article 2 by sensing, and generates a corresponding thermographic thermal image TWB of the inspection article 2. The generated thermographic thermal image of the inspection article 2 is sent to the controller 4.

The depth sensor 3 records body gestures of a user N for the selection of control functions SF and/or for the selection of thermographic measurement results ME, which are projected onto the inspection article 2 by the image projector 5. The control of the thermographic measuring process is then carried out as a function of the body gestures recorded by the depth sensor 3 by sensing. In one possible embodiment, the depth sensor 3 may be a 3D camera which records a body gesture of the user, for example a hand gesture, or alternatively a facial expression of the user, and generates a corresponding three-dimensional image of the body gesture of the user N. This generated three-dimensional image of the body gesture of the user N is sent from the depth sensor 3 to the controller 4. The controller 4 evaluates the generated three-dimensional image of the body gesture of the user N in order to determine the control function SF selected by the user N or the measurement results ME selected by the user N. For example, the body gesture may be a hand gesture with which the user N makes a thumbs-up or thumbs-down. Any other body gestures may likewise be recorded, for example a victory sign or a circle formed with the hand (OK sign). As can be seen from FIG. 1, the system 1 does not use any known input devices, such as a keyboard or computer mouse, for the input of control commands or the selection of control functions SF or thermographic measurement results ME. The body gesture control used in the system 1 is used so that all input devices can be obviated. This allows straightforward conduct of measurement runs with a multiplicity of measuring processes. In this way, measurements can be carried out more rapidly overall. Furthermore, the quality of the evaluation of the inspection article 2 is increased, and the entire measurement run or measurement sequence can be carried out by the user N while saving time. Furthermore, the system 1 makes it possible that a measurement computer does not have to be placed in immediate proximity to the inspection station, so that the flexibility can be increased further in this way.

In one possible embodiment of the system 1 as represented in FIG. 1, the thermographic measuring process is an active thermographic measuring process, in which energy is introduced into the inspection article 2 by an external energy source, the inspection article 2 radiating the introduced energy as heat and the radiated heat being recorded by the thermal imaging camera 6 by sensing. As an alternative, the thermographic measuring process may also be a passive thermographic measuring process, in which the inspection article 2 itself has an internal energy source, the energy of which the inspection article 2 radiates as heat. The radiated heat is again recorded by the thermal imaging camera 6 by sensing, the thermal imaging camera 6 generating a corresponding thermographic thermal image TWB of the inspection article 2 and sending this to the controller 4. The generated thermographic thermal image TWB may subsequently be projected as a thermographic measurement result ME by the image projector 5 directly onto the surface of the inspection article 2 in a way which is visible to the user N.

In another possible embodiment of the system 1, a movement and/or an orientation of the depth sensor 3 and/or of the thermal imaging camera 6 is also controlled by the controller 4 as a function of a body gesture of the user N recorded by sensing. In this way, the user N can make the thermal imaging camera 6 move relative to the surface of the inspection article 2 to be inspected, in accordance with his wishes. For example, the user N may control the orientation of the depth sensor 3 by his body gestures. In another possible embodiment of the system 1, by his body gestures, the user N may furthermore control the location or position of the inspection article 2 to be inspected in absolute or relative terms with respect to the user N by corresponding body gestures. In another possible embodiment, the user N may furthermore control or set his own position, in particular working position, in absolute or relative terms with respect to the inspection article 2 to be inspected, with the aid of his body gestures.

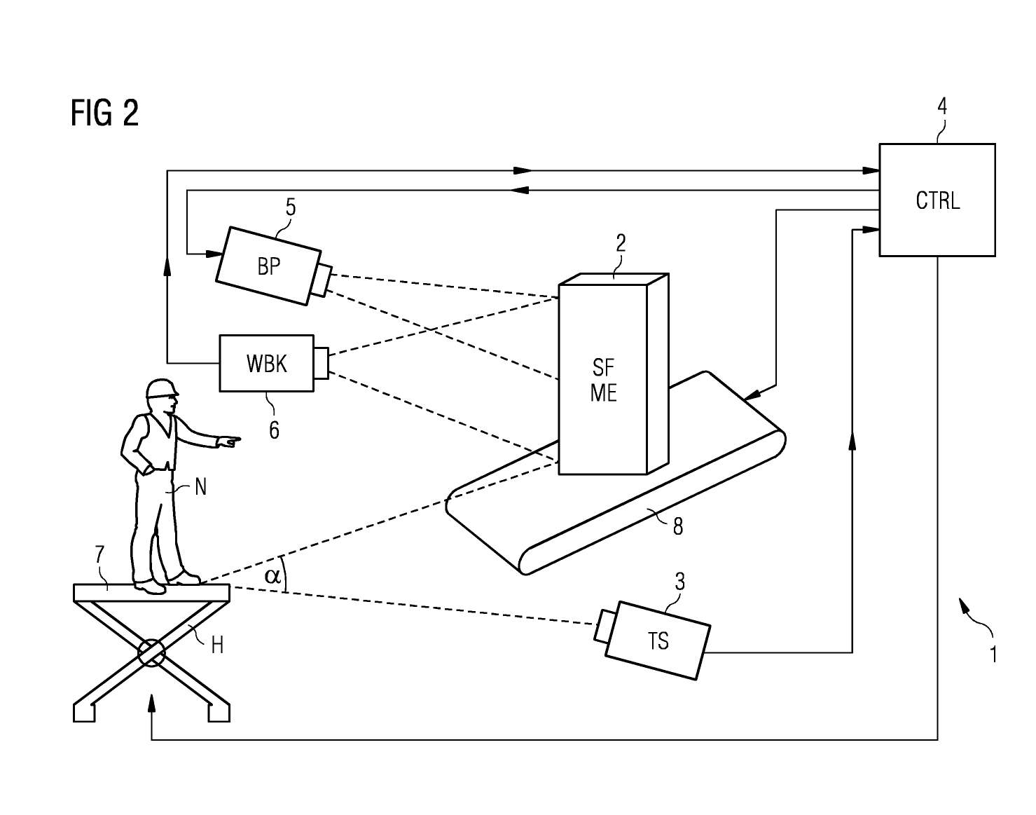

FIG. 2 shows an exemplary embodiment of the system 1, in which the user N is located on a lifting mechanism 7. By his body gestures, the user N can in this way operate the lifting mechanism 7, for example so as to change his height position on the platform of the lifting mechanism 7. In the exemplary embodiment represented in FIG. 2, the inspection article 2 is located on a conveyor belt 8. In the exemplary embodiment represented in FIG. 2, the user N can furthermore drive the conveyor belt 8 by the recorded body gestures, for example so as to move the inspection article 2 to be inspected in his direction. The selection of the control functions SF and/or the thermographic measurement results ME is carried out as a function of the body gestures of the user N recorded by sensing. The control functions SF may involve a very wide variety of control functions SF. For example, the control function is a control function for the selection of a thermographic measurement result ME, which is projected onto the inspection article 2. Furthermore, the control function SF may also be a control function for the selection of a thermographic measurement method used in this case. The control functions SF furthermore include control functions for the selection and/or setting of measurement parameters. The user N may also activate control functions for the loading of existing measurement results and/or measurement data of the inspection article 2 by his body gestures. Further possible control functions SF include the marking of at least one subregion of the inspection article 2, or control functions SF for the erasing or deletion of projected measurement results ME and/or measurement data of the inspection article 2. Further control functions SF include control functions for the zooming of the thermal imaging camera 6 in a particular spatial measurement region of the inspection article 2. Further control functions SF of the system 1 are control functions for the evaluation of the inspection article 2 by the user N. The user N may also automatically generate measurement reports for the respective inspection article 2 with the control functions SF. The control functions SF furthermore include control functions for the evaluation of the thermographic measurement results ME of the respective inspection article 2.

In one possible embodiment of the system 1, a particular control function SF is assigned to each action, in particular each body gesture. At the start of a measurement, for example, a control function menu may be projected onto the inspection article 2 to be inspected with the aid of a beam, or the image projector 5. The depth sensor 3 may, for example, track the movement of the hand of the user N, which is used here as a pointer. For example, the selection of the desired menu position or control function SF is carried out by moving along the menu position by hand. For example, the user or tester may make a selection. He may, for example, select a measurement method, determine a measurement range, interrogate measurement data, or carry out defect dimensioning, if the measurement result for the respective inspection article 2 is already available.

After selection of the measurement method by the user N, the system 1 is ready for the thermographic measurement. After selection of the measurement method, the start of the measurement may for example be instigated by a particular “photographing” gesture. Furthermore, the thermographic measurement may be interrupted by the user N at any time by a special “waving” gesture. As soon as the thermographic measurement has been successfully concluded, the evaluation of the measurement result ME begins. The measurement result ME may be projected onto the inspection article or component 2. For example, the tester or user N may be provided with the following gesture-controlled control functions SF:

marking a desired position,

marking within the projected measurement data,

zooming onto a desired measurement region.

Furthermore, a decision may be made about the state of the respective inspection article 2. Using a special “thumbs-up” body gesture, the user N may then express the fact that the inspection path or inspection article 2 is acceptable in his opinion, for example is fault-free. Using the “thumbs-down” body gesture, the user N or tester expresses the fact that the inspection article 2 is not fault-free in his opinion.

After conclusion of a measurement run, a report of the respective inspection article 2 may be generated, and optionally overlaid, according to the wishes of the user N. Functions, for example scrolling or zooming, may likewise be carried out by gesture control.

In one possible embodiment of the system 1, further additional control functions may be made available for certain measurement methods. In flash thermography, for example, a pilot light may be switched off and on by gestures of the user N. When induction thermography is being used, sampling may for example be triggered by a body gesture of the user N. In addition, when evaluating 3D data sets, as may be encountered for example in X-ray computed tomography or ultrasound scans, on one level with the aid of a particular body gesture, for example “finger snapping”, scrolling may be carried out or alternatively the inspection object or inspection article 2 may be rotated about a particular spatial axis with the aid of a body gesture, for example “hand rotation”.

In one possible embodiment of the system 1, the depth sensor 3 is arranged, at an adjustable angle a with respect to a connecting line extending between the user N and the inspection article 2, in order to record the body gestures of the user N and/or the control functions 2 projected onto the inspection article 2, as well as the projected measurement results ME, in a spatial relation with the respective user N. In this way, further information content is provided since, in this embodiment, not just the body gesture of the user N itself is recorded, but also its relation with the respective inspection article 2 to be inspected. For example, in this way it is possible to record whether the user N is pointing at a particular region of the inspection article 2 or, for example, is pointing away from the inspection article 2. For example, in this way the user N can point to a particular region or a particular position of the inspection article 2, and thereby initiate zooming of the thermal imaging camera 6 onto the position pointed to.

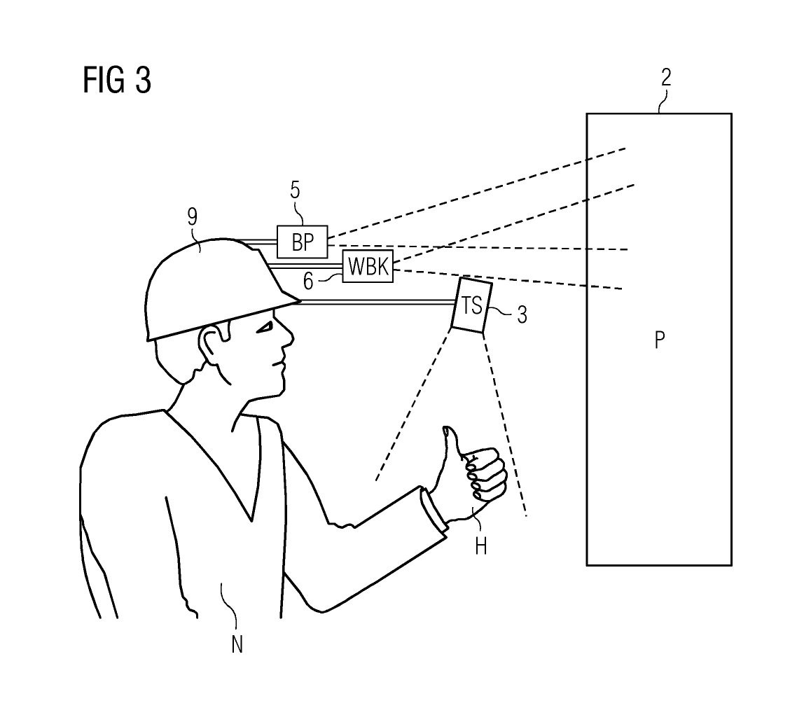

FIG. 3 shows another exemplary embodiment of the system 1 for controlling a thermographic measuring process on an inspection article 2. In the exemplary embodiment represented, the depth sensor 3, the image projector 5 and the thermal imaging camera 6 are fitted on a helmet 9 which is worn by a user N. Furthermore, the controller 4 may likewise be integrated in the helmet 9. As can be seen from FIG. 3, the depth sensor 3 is directed at a region which lies directly in front of the user N. In this region, for example with his hand H, the user can perform body gestures which are recorded by the depth sensor 3. Furthermore, the depth sensor 3 may also be directed at the face of the user N, in order to record the facial expression of the user N. The control of a thermographic measuring process on the inspection article 2 is then carried out as a function of the body gestures recorded, in particular the facial expression recorded and the manual body gestures of the user N. In an alternative embodiment, only the depth sensor 3 and the controller 4 are located on the helmet 9 of the user N, the controller 4 communicating with the image projector 5 and the thermal imaging camera 6 via a wireless interface. As an alternative, only the depth sensor 3, which delivers data to a distant controller 4 via a wireless interface, may be located on the helmet 9. In the exemplary embodiment represented in FIG. 3, the user N himself is carrying the system 1 for controlling the thermographic measuring process on an inspection article 2, for example in a helmet 9 worn by him. The system therefore provides in one possible embodiment a helmet 9 with an integrated system 1 for controlling a thermographic measuring process on an inspection article 2, in which case the helmet may include a depth sensor 3, a controller 4, and optionally also an image projector 5 and a thermal imaging camera 6. In one possible embodiment, the helmet 9 may also be a diving helmet, which, for example, is worn by a diver when inspecting an oil platform or the like. The inspection article 2 may be any manufactured item, for example a turbine blade, a transmission, gearwheels, wind turbine blade or chip package. Furthermore, the inspection article may also include parts of a construction or of a building.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-16. (canceled)

17. A system for controlling a thermographic measuring process on an inspection article, onto which control functions and/or thermographic measurement results are projected, comprising:
at least one depth sensor detecting body gestures of a user indicating selection of at least one of the control functions and the thermographic measurement results; and
a controller controlling the thermographic measuring process as a function of the body gestures detected by the at least one depth sensor.

18. The system as claimed in claim 17, wherein the at least one depth sensor includes a three-dimensional camera which detects at least one of a hand gesture and a facial expression of the user and generates a corresponding three-dimensional image of the body gesture of the user.

19. The system as claimed in claim 18, wherein the controller is connected to the at least one depth sensor, evaluates the three-dimensional image of the body gesture and determines at least one of the control function and the measurement results selected by the user.

20. The system as claimed in claim 19, further comprising an image projector connected to the controller and projecting the control functions and/or the thermographic measurement results onto the inspection article.

21. The system as claimed in claim 20, wherein the thermographic measuring process is an active thermographic measuring process, in which energy is introduced into the inspection article by an external energy source and is radiated as heat by the inspection article.

22. The system as claimed in claim 20, wherein the thermographic measuring process is a passive thermographic measuring process, in which the inspection article has an internal energy source and the inspection article radiate heat produced by the internal energy source.

23. The system as claimed in claim 22, further comprising a thermal imaging camera sensing the heat radiated by the inspection article and generating a thermographic thermal image of the inspection article.

24. The system as claimed in claim 23, wherein the image projector projects the thermographic thermal image of the inspection article as a thermographic measurement result onto the inspection article.

25. The system as claimed in 24, wherein the controller controls a movement and an orientation of at least one of the depth sensor and the thermal imaging camera as a function of the body gesture of the user.

26. The system as claimed in claim 25, wherein the control functions projected onto the inspection article include menu control functions.

27. The system as claimed in claim 26, wherein the control functions include at least one of
selection control functions for selection of at least one of a thermographic measurement method, a spatial and/or temporal measurement range and selection and/or setting of a measurement parameter,
loading control functions for loading of existing measurement results and/or measurement data of the inspection article,
marking control functions for marking of at least one subregion of the inspection article,
erasing control functions for erasing or deletion of projected measurement results and/or measurement data of the inspection article,
replacement control functions for replacement of a part of the measurement results with a bright region as a virtual flashlight,
zooming control functions for zooming of the thermal imaging camera onto a spatial measurement range of the inspection article,
evaluation control functions for evaluation of the inspection article,
generation control functions for generation of a measurement report for the inspection article, and
evaluation control functions for evaluation of the thermographic measurement results of the inspection article.

28. The system as claimed in claim 27, wherein the depth sensor is arranged at an adjustable angle relative to a connecting line extending between the user and the inspection article, to detect the body gestures of the user and/or the control functions projected onto the inspection article and projected measurement results in a spatial relation with respect to the user.

29. The system as claimed in claim 28, further comprising a helmet of the user on which is mounted at least one of the depth sensor, the thermal imaging camera and the image projector.

30. The system as claimed in claim 29, further comprising a lifting mechanism moving the user, the lifting mechanism controlled as a function of the body gestures of the user.

31. A method for controlling a thermographic measuring process on an inspection article, onto which control functions and/or thermographic measurement results are projected, comprising:
sensing body gestures of a user selecting the control functions and/or the thermographic measurement results; and
controlling the thermographic measuring process as a function of the body gestures.

32. An input device in a control system controlling a thermographic measuring process on an inspection article onto which control functions and/or thermographic measurement results are projected by detecting body gestures of a user indicating selection of at least one of the control functions and the thermographic measurement results using at least one depth sensor, comprising:
a helmet; and
at least one of a depth sensor, a thermal imaging camera and an image projector mounted on the helmet.
